(19) United States
(12) Patent Application Publication
(10) Pub. No.: US 2009/0261665 A1
(43) Pub. Date: Oct. 22, 2009

(54) ELECTROMAGNETIC VIBRATING MECHANISM

(76) Inventor: Leao Wang, Taichung (TW)

Correspondence Address: Leao Wang, 13F, No. 23, Jiun-Ho Street, Beitun District, Taichung, 406, TW

(21) Appl. No.: 12/104,445

(22) Filed: Apr. 17, 2008

(51) Int. Cl. H02K 33/00

(52) U.S. Cl. 310/24

(57) ABSTRACT

An electromagnetic vibrating mechanism having a pair of electromagnetic sensors disposed at both sides of a vibrating plate. Each of the electromagnetic sensors consists of one horseshoe-shaped solenoid and two permanent magnets disposed at the rim of the vibrating plate. The horseshoe-shaped solenoid is provided with a first coil and a second coil at both ends thereof. In this way, an electromagnetic output having different polarity is achieved when the current is applied. Furthermore, the polarity can be duly changed by means of input of electric current in different directions. Besides, each of the permanent magnets includes an upper magnet and a lower magnet. The magnets are positioned in such a manner that the polarities thereof are different in lateral direction. Meanwhile, the horseshoe-shaped solenoid is employed to create an up-and-down vibration.

### BACKGROUND OF THE INVENTION

1. Fields of the Invention

The invention relates to an electromagnetic vibrating mechanism, and more particularly, to a structure for ensuring and prolonging the service life of electromagnetic sensors. Moreover, the loss of the magnetic force can be considerably avoided.

2. Description of the Related Art

The application of the induced magnetism by use of solenoid and permanent magnet for creating a vibrating mechanism has been disclosed in U.S. Pat. No. 3,830,099, U.S. Pat. No. 7,141,029, U.S. Pat. No. 5,693,990 and U.S. Pat. No. 4,788,968 (see FIGS. 6 through 9). According to U.S. Pat. No. 3,830,099, U.S. Pat. No. 7,141,029 and U.S. Pat. No. 5,693,990, a solenoid 11 and a vibrating element 10 are combined in a body while a permanent magnet 12 is disposed on a base 13 such that the solenoid 11 is moved with the vibrating element 10. This configuration obviously does harm to the electronic circuit (not shown) of the solenoid 11. Meanwhile, the service life thereof will be reduced as well.

According to U.S. Pat. No. 5,693,990, the solenoid 11 is has a fixed design. An upper permanent magnet 14 is moved with a vibrating element 10 while a lower permanent magnet 15 is unmovably fixed on a base 13. In other words, the gap between both permanent magnets 14, 15 unceasingly varies. According to the theoretical principle, the electromagnetic effect between the solenoid 11 and the upper permanent magnets 14, 15 will be lessened especially when the vibrating element 10 rises. Therefore, the exercise intensity of the vibrating element 10 can be increased.

### SUMMARY OF THE INVENTION

A first object of the invention is to provide an electromagnetic vibrating mechanism having a solenoid fixed at a certain position and a permanent magnet unit movable with a vibrating plate for ensuring and prolonging the service life of electromagnetic sensors. Moreover, the connection line of the upper and lower magnets of the permanent magnets is aligned with the magnetic force midline e of the coils of the horseshoe-shaped solenoid such that both magnets are always subject to the magnetic force of the coils when the vibrating plate moves. In this way, the loss of the magnetic force can be effectively avoided.

A pair of electromagnetic sensors is disposed at both sides of a vibrating plate. Each of the electromagnetic sensors consists of one horseshoe-shaped solenoid and two permanent magnets disposed at the rim of the vibrating plate. The horseshoe-shaped solenoid is provided with a first coil and a second coil at both ends thereof. In this way, an electromagnetic output having different polarity is achieved when the current is applied. Furthermore, the polarity can be duly changed by means of input of electric current in different directions. Besides, each of the permanent magnets includes an upper magnet and a lower magnet. The magnets are positioned in such a manner that the polarities thereof are different in lateral direction. Meanwhile, the horseshoe-shaped solenoid is employed to create an up-and-down vibration.

### BRIEF DESCRIPTION OF THE DRAWINGS

The accomplishment of this and other objects of the invention will become apparent from the following description and its accompanying drawings of which:

FIG. 1 is a schematic drawing of a preferred embodiment of the invention;

FIG. 2 is a cross-sectional view taken along the line A-A in FIG. 1;

FIG. 3 is a cross-sectional view taken along the line B-B in FIG. 1;

FIG. 4 is a schematic drawing of an electromagnetic vibrating mechanism in accordance with the invention applied to an electric treadmill;

FIG. 5 is a cutaway view of the structure of FIG. 4;

FIG. 6 is a schematic drawing of the structure in accordance with U.S. Pat. No. 3,830,099;

FIG. 7 is a schematic drawing of the structure in accordance with U.S. Pat. No. 7,141,029;

FIG. 8 is a schematic drawing of the structure in accordance with U.S. Pat. No. 5,693,990; and

FIG. 9 is a schematic drawing of the structure in accordance with U.S. Pat. No. 4,788,968.

### DETAILED DESCRIPTION OF THE PREFERRED EMBODIMENT

The present invention will now be described in more detail hereinafter with reference to the accompanying drawings that show various embodiments of the invention.

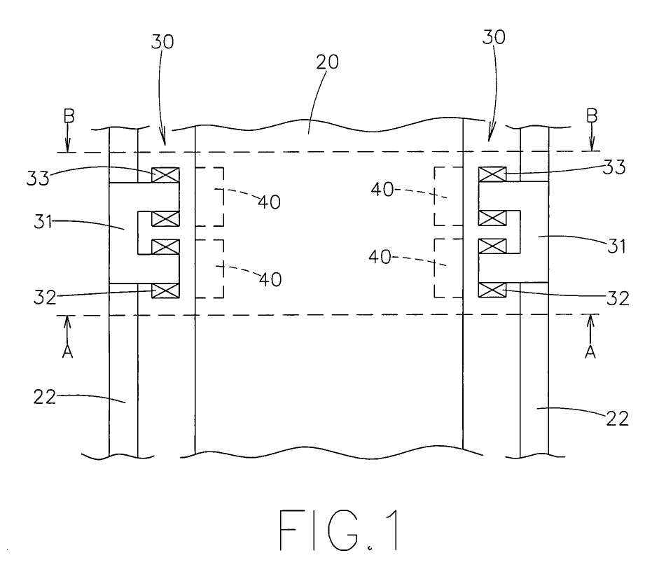

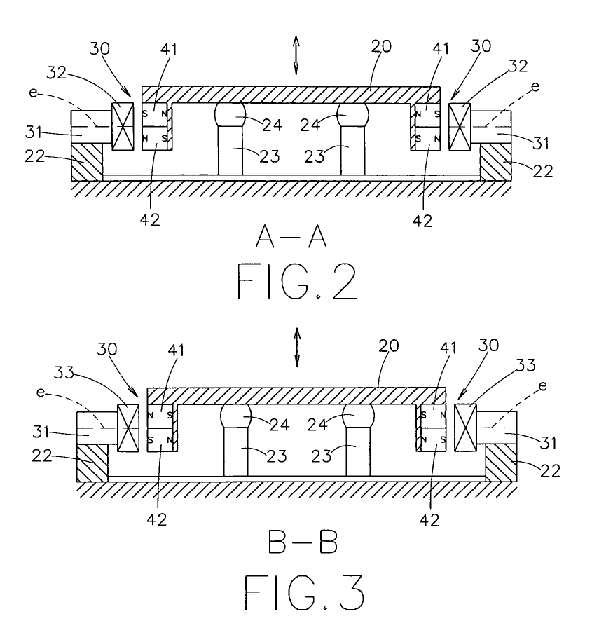

Referring to FIGS. 1, 2 and 3, a pair of electromagnetic sensors 30 is disposed at both sides of a vibrating plate 20. Each of the electromagnetic sensors 30 consists of one horseshoe-shaped solenoid 31 and two permanent magnets 40 disposed at the rim of the vibrating plate 20. The horseshoe-shaped solenoid 31 is provided with a first coil 32 and a second coil 33 at both ends thereof. In this way, an electromagnetic output having different polarity is achieved when the current is applied. Furthermore, the polarity can be duly changed by means of input of electric current in different directions. Besides, each of the permanent magnets 40 includes an upper magnet 41 and a lower magnet 42. The magnets 41, 42 are positioned in such a manner that the polarities thereof are different in lateral direction. Meanwhile, the horseshoe-shaped solenoid 31 is employed to create an up-and-down vibration.

The connection line of the upper and lower magnets 41, 42 of the permanent magnets 40 is aligned with the magnetic force midline e of the coils 32, 33 of the horseshoe-shaped solenoid 31 such that both magnets 41, 42 are always subject to the magnetic force of the coils 32, 33 when the vibrating plate 20 moves. In this way, the loss of the magnetic force can be effectively avoided. In other words, the second coil 33 must be north pole when the first coil 32 is south pole. Thus, when the electric current is applied to the horseshoe-shaped solenoid 31, the lower magnet 42 of the permanent magnets 40 moves upward to approach to the magnetic force midline e according to the principle that unlike magnetic poles attract each other. When the direction of the electric current is so changed that the polarities of the coils 32, 33 are exchanged, the upper magnet 41 moves downward to approach to the magnetic force midline e. As a result, the up-and-down vibration is achieved.

In order to achieve an effective restriction of the vibration intensity, a supporting rod 23 is disposed at the center of a fixing base 22. Moreover, a cushioning element 24 is attached to the top of the supporting rod 23 while the other end of the cushioning element 24 is connected to the bottom of the vibrating plate 20.

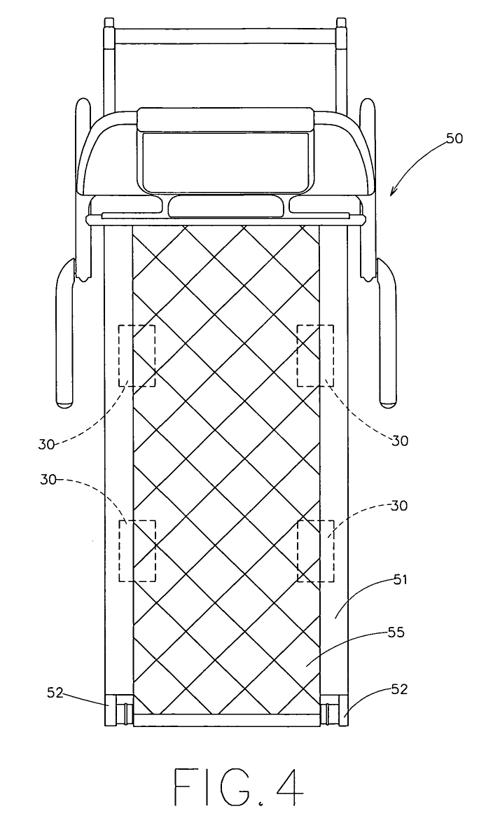

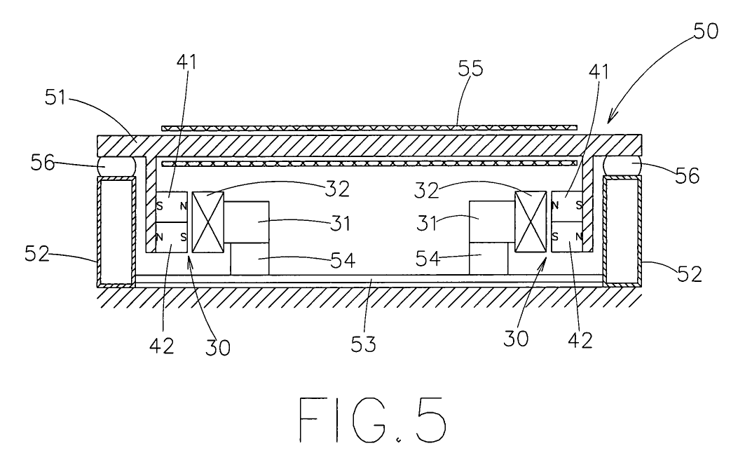

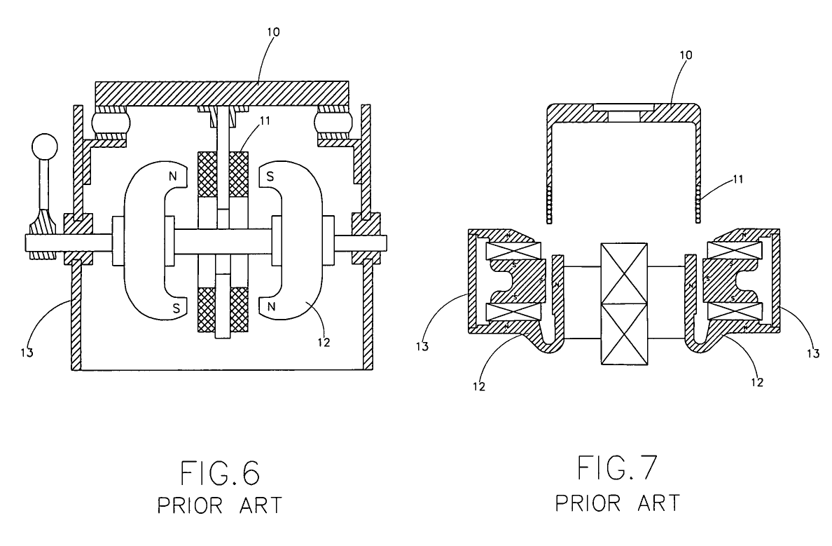

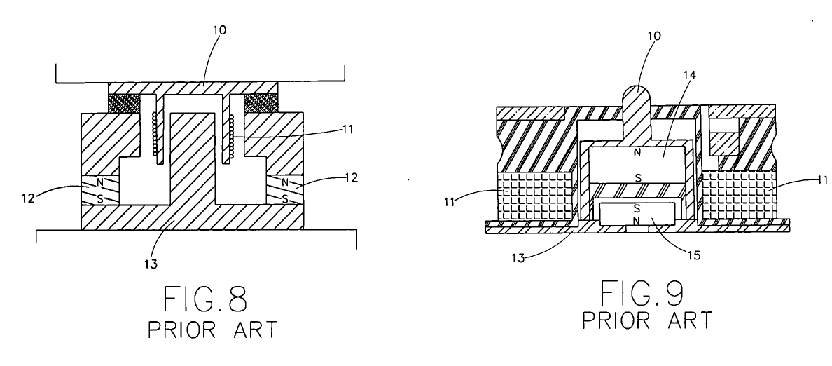

According to the above-mentioned principle, as shown in FIGS. 4 and 5, the present invention can be applied to an exercise apparatus such as electric treadmill 50. The electromagnetic sensors 30 are disposed at the bottom of a running board 51 while both magnets 41, 42 are positioned at both sides of the running board 51. Moreover, the horseshoe-shaped solenoid 31 is secured to a supporting rod 54 of a lateral shaft 53 of the base frame 52. In this way, the running board 51 creates an up-and-down vibration without affecting the original rotation effect of a continuous moving belt 55. In addition, a cushioning element 56 is interposed between the running board 51 and the base frame 52.

Many change and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. An electromagnetic vibrating mechanism comprising a pair of electromagnetic sensors disposed at both sides of a vibrating plate, each of the electromagnetic sensors consisting of one horseshoe-shaped solenoid and two permanent magnets disposed at the rim of the vibrating plate
wherein the horseshoe-shaped solenoid is provided with a first coil and a second coil at both ends thereof; in this way, an electromagnetic output having different polarity is achieved when the current is applied while the polarity can be duly changed by means of input of electric current in different directions; and
wherein each of the permanent magnets includes an upper magnet and a lower magnet, and the magnets are arranged in such a manner that the polarities thereof are different in lateral direction while the horseshoe-shaped solenoid is employed to create an up-and-down vibration.

2. The electromagnetic vibrating mechanism as recited in claim 1, wherein the connection line of the upper and lower magnets of the permanent magnets is aligned with the magnetic force midline e of the coils of the horseshoe-shaped solenoid.

3. The electromagnetic vibrating mechanism as recited in claim 1, wherein a cushioning element is secured to the bottom of the vibrating plate via a supporting rod.

4. An electromagnetic vibrating mechanism applied to an electric treadmill wherein more than one pair of electromagnetic sensors is disposed at both sides of a running board, each of the electromagnetic sensors consisting of one horseshoe-shaped solenoid and two permanent magnets disposed at the rim of the vibrating plate
wherein the horseshoe-shaped solenoid is provided with a first coil and a second coil at both ends thereof; in this way, an electromagnetic output having different polarity is achieved when the current is applied while the polarity can be duly changed by means of input of electric current in different directions; and
wherein each of the permanent magnets includes an upper magnet and a lower magnet, and the magnets are arranged in such a manner that the polarities thereof are different in lateral direction while the horseshoe-shaped solenoid is employed to create an up-and-down vibration.

5. The electromagnetic vibrating mechanism as recited in claim 4, wherein the electromagnetic sensors are disposed at the bottom of a running board while both magnets are positioned at both sides of the running board, and wherein the horseshoe-shaped solenoid is secured to a supporting rod of a lateral shaft of a base frame, thereby creating an up-and-down vibration of the running board without affecting the original rotation effect of a continuous moving belt, and wherein a cushioning element is interposed between the running board and the base frame.
